(19) United States
(12) Patent Application Publication
(10) Pub. No.: US 2026/0359920 A1
(43) Pub. Date: Nov. 12, 2026

(54) MONITORING METHOD AND MONITORING SYSTEM OF CONSTRUCTION SITE SAFETY BASED ON LARGE MODEL AND RAG

(71) Applicants: Southwest Jiaotong University, Chengdu (CN); Chongqing University, Chongqing (CN)

(72) Inventors: Hongtuo Qi, Chongqing (CN); Wenchen Shan, Chengdu (CN); Jiepeng Liu, Chongqing (CN); Xuhong Zhou, Chongqing (CN)

(21) Appl. No.: 19/234,285

(22) Filed: Jun. 11, 2025

(30) Foreign Application Priority Data
May 7, 2025 (CN) 202510581023.4

(51) Int. Cl. G06Q 50/26; G06Q 50/08; G06V 20/52; G06V 40/10; G06V 40/20; G10L 15/18

(52) U.S. Cl. CPC G06Q 50/265; G06Q 50/08; G06V 20/52; G06V 40/10; G06V 40/20; G10L 15/1822

(57) ABSTRACT

A monitoring method and system of construction site safety based on large model and RAG are provided. The method includes: performing intelligent parsing on real-time video data of a construction area based on visual and audio large models, identifying behavioral safety of construction workers, violation operations, dangerous facilities and environmental risks, adding time labels to parsed safety event texts to thereby form safety event logs of a construction site, reasoning and analyzing the safety event logs to determine whether safety early warnings are generated, pushing early warning information, conducting on-site intelligent voice broadcast based on the early warning information, constructing a safety log database of the construction site, a public construction safety management database, and an enterprise internal safety management database through a multi-RAG architecture, and storing construction safety information by a vector database and a graph database. Defects of insufficient real-time monitoring and limited intelligent analysis are solved.

### TECHNICAL FIELD

The disclosure relates to the technical field of intelligent monitoring of construction sites, and more particularly to a monitoring method and a monitoring system of construction site safety based on large model and retrieval-augmented generation (RAG).

### BACKGROUND

In recent years, with development of artificial intelligence, big data and computer vision technology, intelligent monitoring technology of construction sites has developed rapidly. Video monitoring system in related art is mainly used to collect and transmit on-site video data for managers to view and supervise remotely. However, this method still relies on manual judgment and is limited by experience and energy of the managers, so it is difficult to realize real-time, efficient and intelligent safety supervision. Especially in complex construction environments, the video monitoring systems in the related art have difficulty in effectively identifying dangerous behaviors, violation operations, and potential safety hazards, easily leading to blind spots in supervision, thereby increasing construction safety risks.

Construction site safety management involves a large number of national norms, industry standards, and internal rules and regulations of enterprises. The managers need to supervise construction behaviors in accordance with these regulations to ensure that a construction process meets safety requirements. However, environment at the construction sites is complex and ever-changing, making it difficult for manual monitoring to ensure comprehensiveness, accuracy, and consistency. Meanwhile, a large amount of safety event information generated during the construction process, needs to be recorded, classified, and analyzed for subsequent summarization and optimization of management measures. Manual management in the related art is not only time-consuming and laborious, but also difficult to make full use of enterprise information management means to improve efficiency and quality of construction safety management.

Although the intelligent monitoring technology in the related art can use computer vision to recognize status of construction workers and equipment, it is mainly limited to static analysis of image content, and is unable to perform in-depth safety risk reasoning and dynamic early warning. Additionally, a safety management information system in related art is often limited to data storage and simple queries, lacking intelligent analysis ability based on knowledge bases, and unable to provide accurate management suggestions for specific construction scenes. Therefore, how to use multi-task large model (MTLM) and multimodal RAG (multi-RAG) technology to realize intelligent perception, reasoning analysis, automatic early warning and intelligent interaction of construction site safety becomes a key technical challenge in the field of construction safety management.

### SUMMARY

Technical problem to be solved by the disclosure is to provide a monitoring method and a monitoring system of construction site safety based on large model and RAG to solve problems of insufficient real-time monitoring ability, limited intelligent analysis ability and lack of effective knowledge base support in construction site safety supervision in related art.

To achieve above objective, the disclosure provides following technical solutions.

Specifically, the monitoring method of construction site safety based on large model and RAG according to an embodiment of the disclosure includes:
step S1, collecting, by multiple video collection devices deployed at a construction site, real-time video data and real-time voice input data of a construction area, in which timeline of the real-time voice input data is matched with that of the real-time video data;
step S2, performing intelligent parsing on the real-time video data of the construction area based on a visual large model, automatically identifying behavioral safety of construction workers, violation operations, dangerous facilities and environmental risks, generating structured data to obtain parsed safety event texts, and adding time labels to the parsed safety event texts to thereby form safety event logs of the construction site;
step S3, processing the real-time voice input data of the construction area by using methods of denoising, framing, acoustic feature extracting to obtain processed voice input data, analyzing the processed voice input data by using speech large model to identify abnormal operation of equipment, distress calls from personnel, voice commands and safe communication contexts to thereby obtain voice data analysis result, and integrating the voice data analysis result with the parsed safety event texts to form a more comprehensive and in-depth understanding of safety events;
step S4, performing intelligent analysis on the safety event logs, extracting key regulatory information, evaluating safety risk levels to obtain reasoning analysis results, determining whether safety early warnings are generated based on the reasoning analysis results, and pushing early warning information when the safety early warnings are generated;
step S5, conducting on-site intelligent voice broadcast based on the early warning information;
step S6, constructing a safety log database of the construction site, a public construction safety management database, and an enterprise internal safety management database, and storing construction safety information by using a vector database and a graph database; and
step S7, querying for safety events of the construction site, regulatory recommendations, and accident handling solutions through natural language, and combining a RAG retrieval system with a knowledge base to realize cross-database and cross-modal joint retrieval, to thereby generate intelligent responses (e.g., for displaying by a display and/or for printing by a printer) and display handling basis and measures in time by combining safety events retrieved with detailed provisions of corresponding norms.

In an embodiment, the monitoring method of construction site safety based on large model and RAG includes automatically generating construction safety logs and storing the construction safety logs in a database in combination with safety events images or short videos.

In an embodiment, in the step S5, the safety log database of the construction site, the public construction safety management database, and the enterprise internal safety management database are constructed through a multi-RAG architecture.

In an embodiment, the multiple video collection devices are deployed in an elevated work area, an equipment operation area and a personnel crowded area.

Another embodiment of the disclosure provides the monitoring system of construction site safety based on large model and RAG, including:
a video collection module, configured to collect, by the multiple video collection devices deployed at the construction site, the real-time video data and the real-time voice input data of the construction area;
a visual large model analysis system, configured to perform intelligent parsing on the real-time video data of the construction area, automatically identify behavioral safety of construction workers, violation operations, dangerous facilities and environmental risks, generate the structured data to obtain the parsed safety event texts, and add the time labels to the parsed safety event texts to thereby form the safety event logs of the construction site;
a reasoning analysis module, configured to perform intelligent analysis on the safety event logs, extract the key regulatory information, evaluate the safety risk levels to obtain the reasoning analysis results, determine whether the early safety warnings are generated based on the reasoning analysis results, and push the early warning information when the early safety warnings are generated;
a voice broadcast module, configured to conduct on-site intelligent voice broadcast based on the early warning information;
a RAG retrieval module, configured to construct the safety log database of the construction site, the public construction safety management database, and the enterprise internal safety management database, store the construction safety information by using the vector database and the graph database, and retrieval information in the safety event logs to determine whether a certain type of safety events has occurred and whether safety risk exists within a certain time range; and
a language interaction module, configured to query for the safety events of the construction site, the regulatory recommendations, and the accident handling solutions through the natural language, and combine the RAG retrieval system with the knowledge base to realize cross-database and cross-modal joint retrieval, to thereby generate the intelligent responses.

In an embodiment, the monitoring system of construction site safety based on large model and RAG includes a generation and storage module of construction history log texts, configured to automatically generate the construction safety logs and store the construction safety logs in the database in combination with the safety events images or short videos.

In an embodiment, the multiple video collection devices for the video collection module are deployed in the elevated work area, the equipment operation area and the personnel crowded area.

The disclosure converts the real-time video data of the construction area into key single-frame images, and analyze contents of the key single-frame images by using the visual large model to identify the behavioral safety of construction workers, the dangerous facilities and the environmental risks to thereby obtain analysis results. Subsequently, the disclosure converts the analysis results into text data, and add the time labels to the text data to thereby form the safety event logs of the construction site. The disclosure performs in-depth analysis on the text data by using a reasoning model to extract the key regulatory information, and pushes the key regulatory information to a big screen of a management center or a mobile application (APP) to realize real-time early warning. The disclosure introduces the voice broadcast module to convert the real-time early warning into voice broadcast. The voice broadcast module is configured to conduct intelligent voice broadcast on the construction site or the management center to ensure that the real-time early warning can be quickly conveyed to relevant personnel. In addition, the disclosure uses the multi-RAG architecture to construct the safety log database of the construction site, the public construction safety management database, and the enterprise internal safety management database, and adopts the language interaction module to intelligently interact with managers to provide functions of query, management, and summarization of safety events. Difference between the monitoring system of construction site safety based on large model and RAG and monitoring technologies in the related art lies in a combination of technologies such as computer vision, large model reasoning, and multi-RAG to achieve full-process intelligent supervision of construction site safety, to thereby improve supervision efficiency, and reduce safety risks.

Compared with technologies in related art, the disclosure has following beneficial effects 1 through 4.
1. Multi-task large model is empowered to improve intelligent safety supervision ability. The disclosure uses the visual large model to monitor the construction site, and performs the in-depth analysis in combination with the reasoning model, so that the disclosure can not only identify the behavioral safety of construction workers, but also perform reasoning analysis of potential safety hazards, to thereby improve intelligent monitoring ability.
2. The multi-RAG architecture is used to realize efficient intelligent retrieval and safety management. The disclosure constructs the safety log database of the construction site, the public construction safety management database, and the enterprise internal safety management database, and uses multi-RAG technology to realize fast retrieval, correlation analysis and safety management optimization.
3. Intelligent early warning pushing and voice broadcast are used to improve response efficiency. The disclosure can not only push the early warning information to the management center and the managers, but also convey the early warning information to the construction site by voice broadcast, to thereby improve accessibility of safety supervision and ensure that the construction workers in front-line can receive the early warning information in time.
4. The language interaction model is used to optimize safety management experience. The managers can use the language interaction model to query the safety events of the construction site and obtain national regulations and enterprise safety management recommendations, thereby improving an intelligent level of construction safety management.

To sum up, the disclosure constructs an intelligent monitoring system of construction site safety through multi-task large model + multi-RAG architecture. The intelligent monitoring system of construction site safety can realize real-time monitoring, intelligent reasoning, real-time broadcasting, knowledge retrieval, and management decision-making support for construction safety, thereby effectively improving efficiency of the construction safety management, reducing safety risks, and providing technical support for intelligent development of the construction industry.

### BRIEF DESCRIPTION OF DRAWINGS

To more clearly describe technical solutions in embodiments of the disclosure or in the related art, attached drawings needed in description of the embodiments of the disclosure or technologies in the related art will be briefly introduced below. Apparently, the attached drawings described below are merely some of the embodiments of the disclosure. For those skilled in the art, other attached drawings can be obtained based on the attached drawings without creative labors.

FIG. 1 illustrates a schematic flowchart of a monitoring method of construction site safety based on large model and RAG according to an embodiment of the disclosure.

FIG. 2 illustrates a schematic analytic diagram of a visual large model according to an embodiment of the disclosure.

FIG. 3 illustrates a schematic diagram of multi-RAG according to an embodiment of the disclosure.

FIG. 4 illustrates a schematic architecture diagram of construction safety databases according to an embodiment of the disclosure.

### DETAILED DESCRIPTION OF EMBODIMENTS

Technical solutions in embodiments of the disclosure will be clearly and completely described below with reference to attached drawings of the embodiments of the disclosure. Apparently, the embodiments described are merely some of embodiments of the disclosure, rather than all of embodiments of the disclosure. Based on the embodiments of the disclosure, other embodiments obtained by those skilled in the art without creative labors shall fall within a scope of protection of the disclosure.

To make objectives, features and beneficial effects of the disclosure more obvious and easier to understand, the disclosure will be further described in combination with attached drawings and specific embodiments.

### Embodiment 1

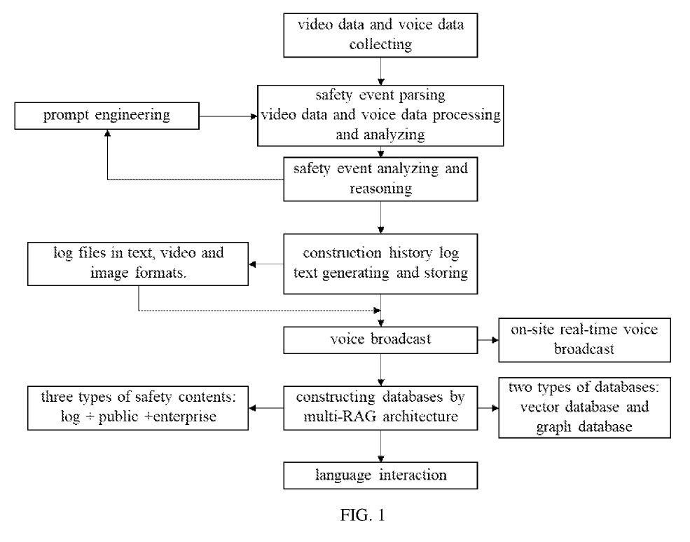

As illustrated in FIG. 1, a monitoring method of construction site safety based on large model and RAG provided by an embodiment of the disclosure includes following step S1 through step S7.

Step S1, real-time video data and real-time voice input data of a construction area is collected by multiple video collection devices deployed at a construction site, and timeline of the real-time voice input data is matched with that of the real-time video data.

Step S2, intelligent parsing is performed on the real-time video data of the construction area based on a visual large model. Behavioral safety of construction workers, violation operations, dangerous facilities and environmental risks are automatically identified, and structured data is generated to obtain parsed safety event texts. Time labels are added to the parsed safety event texts to thereby form safety event logs of the construction site.

Step S3, the real-time voice input data of the construction area is processed by using methods of denoising, framing, acoustic feature extracting to obtain processed voice input data. The processed voice input data is analyzed by using speech large model to identify abnormal operation of equipment, distress calls from personnel, voice commands and safe communication contexts to thereby obtain voice data analysis result. The voice data analysis result is integrated with the parsed safety event texts to form a more comprehensive and in-depth understanding of safety events.

Step S4, intelligent analysis is performed on the safety event logs of the construction site. Key regulatory information is extracted. Safety risk levels are evaluated to obtain reasoning analysis results. Whether safety early warnings are generated is determined based on the reasoning analysis results. Early warning information is pushed when the safety early warnings are generated.

Step S5, on-site intelligent voice broadcast is conducted based on the early warning information.

Step S6, a safety log database of the construction site, a public construction safety management database, and an enterprise internal safety management database are constructed based on a multi-RAG architecture.

Step S7, safety events of the construction site, regulatory recommendations, and accident handling solutions are queried through natural language. A RAG retrieval system is combined with a knowledge base to realize cross-database and cross-modal joint retrieval, to thereby generate intelligent responses and display handling basis and measures in time by combining safety events retrieved with detailed provisions of corresponding norms.

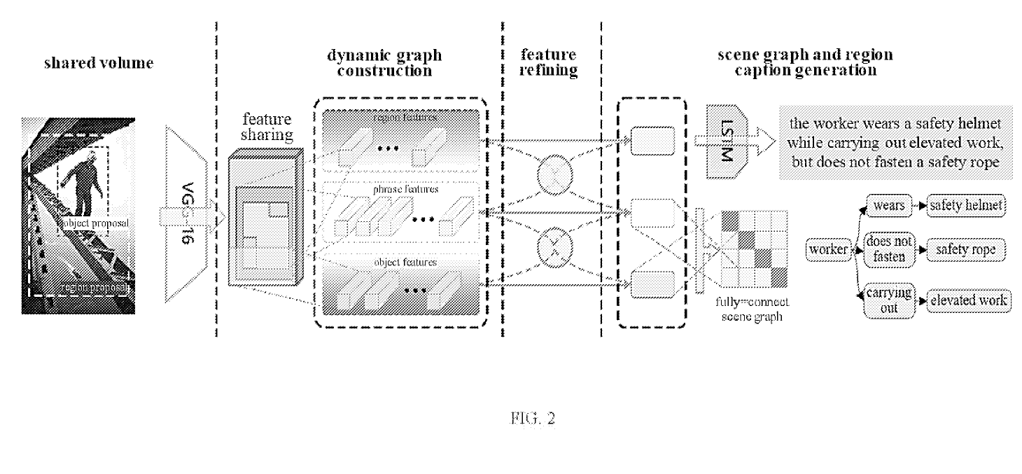

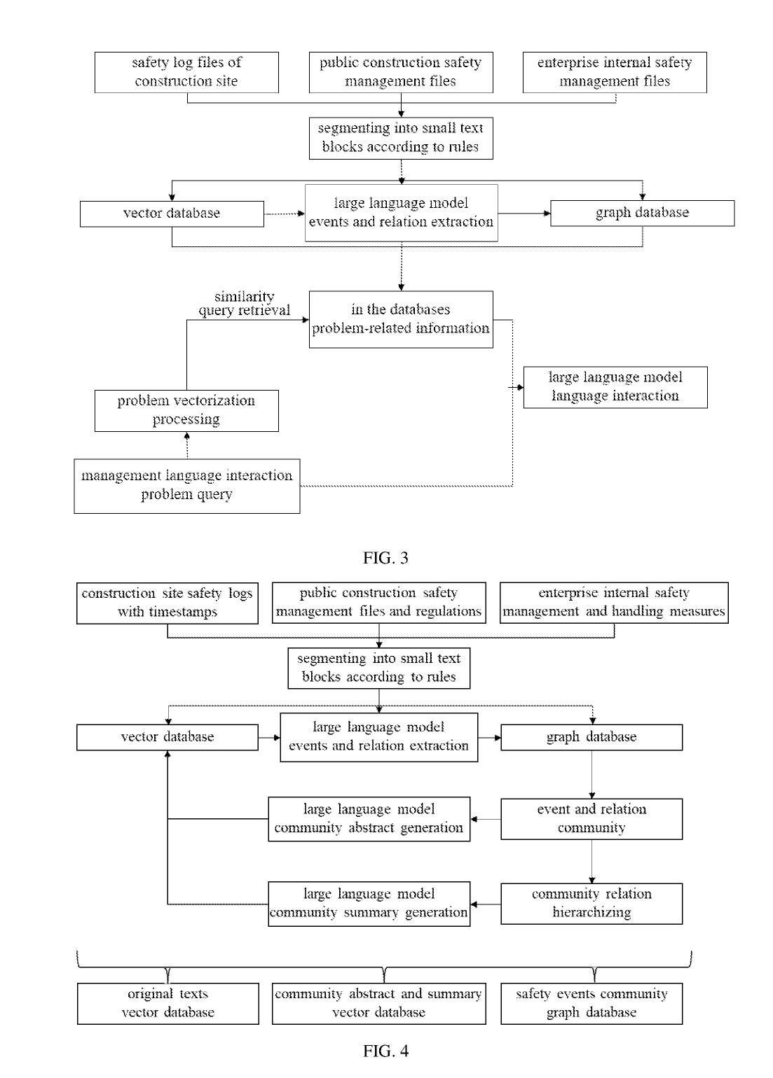

In an embodiment, as illustrated in FIG. 2, the step S2 includes sub-steps (1) through sub-step (3).

Sub-step (1), visual large model (e.g., Qwen-VL, miniCPM, SAM, YOLO, etc.) or fine-tuned visual large model in specific dataset for construction safety scenarios is used to detect wearing of safety helmets and violation behaviors of the construction workers and equipment status on the construction site.

Sub-step (2), optical character recognition (OCR) technology is combined to automatically read contents of construction safety signs and notice boards and to determine whether the contents comply with safety management regulations.

Sub-step (3), structured text data is generated. The structured text data includes event type, occurrence time, occurrence location, involved personnel, violation description, the equipment status, and risk level (low, medium, high), etc.

In an embodiment, the step S4 includes sub-step (1) through sub-step (3).

Sub-step (1), a reasoning analysis model (e.g., GPT, Claude, Gemini, Flash Thinking, DeepSeek, etc.) is used to combine with construction safety rules to logically reason the parsed safety event texts to thereby automatically determine severity of the violation behaviors.

Sub-step (2), a vector database of historical data of the construction site is combined to predict future risks and provide rectification suggestions.

Sub-step (3), optimal accident handling solutions is recommended by comparing similar history events. The optimal accident handling solutions includes handling solutions from history or normative procedures.

In an embodiment, the step S5 includes sub-step (1) through sub-step (3).

Sub-step (1), a hierarchical early warning mechanism is adopted:
low risk: pushing reminder notices to managers;
medium risk: sending APP warning notices and conducting on-site voice broadcast; and
high risk: triggering emergency alarms and construction suspension notices.

Sub-step (2), intelligent voice broadcast supports multi-language and dialect conversion to ensure that all construction workers can understand alarm content.

Sub-step (3), intelligent wearable devices (such as smartphones, tablets, helmets, and walkie-talkies) are combined to send real-time early warning signals to the construction workers.

In an embodiment, the step S6 includes sub-step (1) through sub-step (3).

Sub-step (1), a vector database (e.g., FAISS, Milvus) is used to store construction event logs to thereby support semantic level retrieval.

Sub-step (2), a graph database (e.g., Neo4j) is used to store relationship between construction safety events, to thereby support knowledge map analysis and multi-hop query.

Sub-step (3), the multi-RAG architecture is combined to perform cross-database retrieval on the construction safety events, regulatory information and enterprise management norms, to thereby provide intelligent safety management suggestions.

In an embodiment, as illustrated in FIG. 4, the step S7 includes sub-step (1) through sub-step (3).

Sub-step (1), construction safety is queried. Users can input “Is there a situation where safety helmets are not worn at the construction site?”. A RAG system searches a database and returns violation records of latest 7 days with screenshot or video evidence.

Sub-step (2), regulation is matched. A construction regulations database is combined to provide compliance analysis, for example: “This behavior violates Article X of the ‘Code for Construction Safety’.”.

Sub-step (3), safety events are summarized. A construction safety report can be automatically generated and exported in portable document format (PDF)format or Excel format for review by the managers.

In an embodiment, the monitoring method of construction site safety based on large model and RAG further includes: automatically generating construction safety logs and storing the construction safety logs in the database in combination with safety events images or short videos, specifically including following sub-step (1) through sub-step (4).

Sub-step (1), the construction safety logs are automatically generated. The construction safety logs are automatically generated with the risk level, the violation description and suggested rectification measures based on the visual big model + language model.

Sub-step (2), the safety events images and short videos are stored. Screenshots or short videos (for example, 5-10 seconds) for each safety events will be saved and bound with text of the construction safety logs for subsequent retrospective analysis.

Sub-step (3), intelligent index is constructed. The intelligent index is constructed in multiple dimensions according to time, personnel, and event types etc. by using metadata indexing technology, to thereby improve efficiency of data query.

Sub-step (4), RAG data is converted. Construction history logs are converted into vectorized data by using natural language processing (NLP) technology, to thereby support semantic level similarity and relevance ranking retrieval.

The disclosure combines technologies of MTLM, multi-RAG, voice broadcast and construction safety log storage to realize intelligent safety supervision and real-time early warning of the construction site, history events storage and intelligent regulation retrieval, so as to greatly improve an intelligent level of construction safety management.

The disclosure collects the real-time video data of the construction area by multiple video monitoring terminal equipment (i.e., the multiple video collection devices) deployed at the construction site, and converts the real-time video data of the construction area into key single-frame images. The key single-frame images are input into the visual large model to be intelligently parsed, so as to identify the behavioral safety of construction workers, status of construction equipment, the dangerous facilities and other potential safety hazards. Key information identified by the visual large model is converted into texts, and the time labels are added to the texts to construct complete safety event records of the construction site. The disclosure performs in-depth analysis on the texts by using a reasoning model to extract the key regulatory information, and determines whether there are potential safety hazards. When safety risks and violation operation are detected, real-time early warning information can be pushed to the managers through terminals such as a big screen of a management center or a mobile APP. The disclosure introduces the voice broadcast module to convert the real-time early warning into voice broadcast. The voice broadcast module is configured to conduct real-time intelligent voice broadcast on the construction site or the management center to ensure that the real-time early warning can be quickly conveyed to relevant personnel, to thereby improve a response speed of construction safety management. In an aspect of data storage and management, the disclosure uses the multi-RAG architecture to construct the safety log database of the construction site, the public construction safety management database, and the enterprise internal safety management database. These databases respectively store safety events record of the construction site, national and industry-related construction safety management norms, and internal safety management systems of enterprises. The Managers can interact with the system in natural language through a large language model to query the safety events of the construction site, obtain safety management solutions, and summarize events and optimize safety management based on the history data of the construction site and knowledge base information. Finally, retrieval results are fused by the large model to provide a comprehensive analysis report to the managers to thereby support construction safety management decisions.

### Embodiment 2

A monitoring system of construction site safety based on the large model and RAG provided by another embodiments of the disclosure includes a video collection module, a data transmission device, a visual large model analysis system, a reasoning analysis module, a voice broadcast module, a RAG retrieval module, and a language interaction module. Each module revolves around key factors such as behaviors of construction workers, safety facilities and dangerous areas in the construction site. In some implementations, the video collection device, the visual large model analysis system, the reasoning analysis module, the voice broadcast module, the RAG retrieval module and the language interaction module are embodied by memories and processors coupled to the memories, and the memories are stored with computer programs executable by the processors.

In an embodiment, the video collection module collects, by the multiple video collection devices, the real-time video data and the real time voice input data of the construction area. The multiple video collection devices are deployed at different positions of the construction area to ensure that both activity range of the construction workers and operation area of equipment are within monitoring scopes of the multiple video collection devices. Types of the multiple video collection devices are not limited to cameras, but can also be drones and tracked or quadruped or humanoid inspection robots. The cameras are third generation intelligent network cameras, and the third-generation intelligent network cameras have characteristics of panoramic monitoring, night vision and high-speed frame rate, so as to ensure all-weather real-time monitoring of construction environment. The cameras are deployed at the elevated work area to monitor an overall situation of the construction site and collect videos of the overall situation of the construction site. The drones and tracked or quadruped or humanoid inspection robots are configured to go near the construction site to observe detailed situation of the construction site and collect videos of the detailed situation of the construction site. Both videos collected by the cameras, drones and tracked or quadruped or humanoid inspection robots are transmitted to a server side.

In an embodiment, the data transmission device uses power over ethernet (POE) for power supply and optical fiber transmission to transmit data, so as to ensure the real-time video data and the real-time voice input data of the construction area can be safely and quickly transmitted to the server side. Monitoring data is preliminarily filtered and compressed through switches, routers, and edge computing devices to reduce data transmission delay.

In an embodiment, the visual large model analysis system is configured to analyze the real-time video data of the construction area to automatically identify behavioral safety of construction workers, dangerous facilities and other potential safety hazards. The visual large model analysis system has three functions of: 1, identifying behaviors of the construction workers: to detect whether there are behaviors such as not wearing safety helmets, violation climb, not fastening safety ropes; 2, analyzing operation status of equipment: to identify status of tower operation, excavator operation, construction vehicle driving, etc., and determine whether there is violation operation; and 3, environment assessment: to detect environment factors of obstacles, exposed wires and dangerous objects stacking in the construction area.

In an embodiment, selection of the visual large model includes: using large models commonly used in related art, such as Vision Transformer, Wen Xin Yi Ge, Qian Wen Graphic Model, Shang Tang Rixin SenseNova, Zhipu CogView and CogVLM to combine with computer vision algorithms such as YOLOv8, SAM (Segment Anything Model), CLIP, so as to achieve high-precision identification. Through a way of large model + edge computing, a real-time performance of construction safety identification is improved and a delay problem of cloud processing is avoided.

In an embodiment, applications of the visual large model includes: visual large model such as Qwen-VL or visual large model based on Transformer architecture being able to support object detection, OCR recognition and scene semantic understanding in complex scenes to realize construction site safety monitoring; lightweight multi-modal model, including but not limit to miniCPM visual large model ,being able to run on the edge computing devices to realize real-time analysis of behaviors of construction workers and equipment status; SAM being used to segment object on the construction site to accurately locate construction workers, equipment, and dangerous facilities, and YOLO (You Only Look Once) being used for real-time object detection models, and suitable for efficient monitoring of the construction site.

In an embodiment, a processing flow of the real-time video data of the construction area includes: 1, after collected by the multiple video collection devices, the real-time video data of the construction area being converted into single-frame images; 2, the visual large model analyzing status of construction workers and equipment to obtain analysis result, and converting the analysis result into structured texts; and 3, generating safety event logs to record time, personnel, behavior types and detect results.

In an embodiment, the reasoning analysis module is configured to perform in-depth reasoning and analysis based on the safety events logs generated by the visual large model to determine whether construction behavior is in compliance, and generate safety early warning.

In an embodiment, core analysis logic of the reasoning analysis module includes: when a construction worker does not wear a helmet, the reasoning analysis module determining whether the construction worker is in dangerous operation area; determining whether the construction equipment is overload during an operation process and whether the construction equipment is beyond a safe driving range; and determining whether construction operation complies with safety norms in combination with construction norm database.

In an embodiment, risk hierarchical early warning includes: 1, low risk, for minor violations (such as temporary remove of the safety helmet), only pushing a pop-up window warning; 2, medium risk, for serious violations (such as not following a designated route), pushing warnings via APP or large screen; and 3, high risk, for major hazards (such as crane operation errors, personnel falling), conducting on-site voice alarms + pushing emergency notifications.

In an embodiment, the voice broadcast module converts safety early warning information into voice through large voice models (such as VALL-E/VALL-E, Bark, iFLYTEK Zhisheng, Paraformer series, WeNet, etc.) and intelligently broadcasts the safety early warning information on the construction site.

In an embodiment, functions and features of the voice broadcast module includes: multi-language support (mandarin, dialect, Cantonese, etc.) to meet needs of different construction workers; scene adaptation, to adjust voice broadcast volume and frequency according to different risks level; and cooperation with management system to synchronously push the safety early warning information to the construction management center and the intelligent devices worn by the construction workers.

In an embodiment, for example, when low risk events occur, the voice broadcast module broadcasts: “Attention, please. Construction area is ahead. Please wear your safety helmet.” When high risk events occur, the voice broadcast module broadcasts: “Emergency alert: Danger! Crane operation area, please evacuate immediately!”.

In an embodiment, a multi-RAG retrieval system is used to store knowledge data related to construction safety and supports intelligent retrieval. The multi-RAG retrieval system combines information Retrieval and text Generation, so that when answering user queries, the multi-RAG retrieval system can not only generate answers, but also refer to relevant information in authoritative knowledge base to provide accurate and credible safety management suggestions.

In an embodiment, a retrieval function is specifically as follows: when the managers input queries (such as “How to handle the situation where safety helmets are not worn at the construction site?”), RAG first searches for related regulations, cases, and standards in the public construction safety management database. The vector database and graph database are used to store knowledge related to construction safety, and support efficient, semantic level retrieval.

In an embodiment, an augmentation function is specifically as follows: retrieved information of regulations and management experiences, etc., is input into the large model (such as Qwen-VL, ChatGPT, DeepSeek) for understanding and integration.

In an embodiment, the language interaction module (such as ChatGPT and Claude) is configured to generate clear answers that meet needs of the construction site and automatically generate safety rectification solutions based on retrieved knowledge.

The disclosure uses multi-RAG architecture to construct three safety management databases: 1, the safety log database of the construction site, configured to store violation records and event analysis; 2, the public construction safety management database, configured to store national regulations and industry norms; and 3, enterprise internal safety management database, configured to store the enterprise safety management systems.

A working flow of the language interaction module is specifically as follows: 1, the construction workers and the managers making safety queries through the language interaction module; 2, the multi-RAG system retrieving history events + regulations + enterprise management measures; and 3, the language model (language model such as ChatGPT, Qwen, Claude, and DeepSeek, etc.) integrating information and returning results in form of dialog.

The language interaction module allows construction managers to use natural language to query about safety situation of the construction site.

Examples of query are as follows: “Were there any potential safety hazards at the construction site yesterday?”, “Has a certain type of dangerous behavior occurred in the construction site in a past month?”, “How to deal with a situation that the construction worker does not wear the helmet?”, and “What are safety regulations of the enterprise on elevated work?”.

Returning content is: safety events logs (violation records of yesterday); industry norms (interpretation of relevant laws and regulations); and enterprise safety regulations (internal management measures of the enterprise).

In an embodiment, the monitoring system of construction site safety based on large model and RAG further includes a generation and storage module of construction history log text. The generation and storage module of the construction history log text is configured to automatically generate construction safety logs and store the construction safety logs in the database in combination with safety events images or short videos.

The generation and storage module of the construction history log text supports visual analysis of the construction safety events, including timeline analysis, a heatmap of violation behavior, and accident correlation analysis.
(1) The timeline analysis displays history construction events in a timeline format, supporting quick retrieval of safety issues within a specific period in a past.
(2) The heatmap of violation behavior displays high-frequency areas where violation behaviors occur by using a heatmap, helping the managers to optimize safety protection measures.

The accident correlation analysis combines a technology of knowledge map to analyze correlation between construction accidents, providing decision support for safety management.

The disclosure discloses an intelligent monitoring system of the construction site safety based on multi-task large model + multi-RAG + intelligent voice broadcast.

Beneficial effects of the monitoring system of the construction site safety are: monitoring the construction site in an all-round way to identify violation behaviors efficiently; intelligent reasoning + risk early warning to improve safety supervision ability; voice broadcast + intelligent interaction to optimize user experience; and multi-RAG knowledge base to support regulation query and management optimization.

The disclosure can be widely applied in construction sites such as buildings, bridges and tunnels to improve a construction safety management level and reduce accident risk.

Embodiments described herein are merely for illustrating principles and implementations of the disclosure and are not to limit a scope of the disclosure. All variations and improvements made by those skilled in the art without departing from spirits of the disclosure shall fall within the scope of protection of the disclosure.

What is claimed is:

1. A monitoring method of construction site safety based on large model and retrieval-augmented generation (RAG), comprising the following steps:
step S1, collecting, by a plurality of video collection devices deployed at a construction site, real-time video data and real-time voice input data of a construction area; matching a timeline of the real-time voice input data with a timeline of the real-time video data to establish a matched timeline; preliminarily filtering and compressing monitoring data comprising the real-time video data and the real-time voice input data using one or more switches, one or more routers, and one or more edge computing devices; and transmitting the filtered and compressed monitoring data to a server by optical-fiber transmission;
step S2, converting the real-time video data into key single-frame images; executing, on at least one of the one or more edge computing devices a visual large model that processes the key single-frame images by object detection, optical character recognition (OCR), and scene semantic understanding to identify behavioral safety of construction workers, violation operations, dangerous facilities and environmental risks, converting information identified by the visual large model into structured data comprising event type, occurrence time, occurrence location, involved personnel, violation description, equipment status, and risk level to obtain parsed safety event texts, adding time labels to the parsed safety event texts to thereby form construction-site safety event logs; and, for each construction-site safety event log, saving a screenshot or a short video and binding the screenshot or the short video with text of a corresponding construction-site safety event log;
step S3, processing the real-time voice input data of the construction area by denoising, framing, acoustic feature extracting to obtain processed voice input data, inputting the processed voice input data into a speech large model to identify abnormal operation of equipment, distress calls from personnel, voice commands, and safe communication contexts to thereby obtain voice data analysis result, and integrating the voice data analysis result with the parsed safety event texts according to the matched timeline;
step S4, inputting the construction-site safety event logs into a reasoning analysis model; applying the reasoning analysis model and construction safety rules to perform logical reasoning on the parsed safety event texts, extract key regulatory information, and evaluate safety risk levels to obtain reasoning analysis results, determining whether safety early warnings are to be generated based on the reasoning analysis results, and upon determining that the safety early warnings are to be generated, generating and pushing early warning information;
step S5, conducting on-site intelligent voice broadcast based on the early warning information, specifically comprising: sending real-time early warning signals to wearable devices of construction workers based on the early warning information, and broadcasting the early warning information to the construction workers through the wearable devices thereby improving accessibility of safety supervision and ensuring that the construction workers in front-line can receive the early warning information in time;
step S6, constructing a construction-site safety log database a public construction safety management database, and an enterprise internal safety management database, storing the construction-site safety event logs and the screenshots or short videos bound thereto in the construction-site safety log database; constructing a metadata index of the construction-site safety event logs according to time, personnel, and event type; converting the construction-site safety event logs into vectorized data using natural language processing technology; storing the vectorized data representing the construction-site safety event logs in a vector database for semantic-level similarity and relevance-ranking retrieval; and storing relationships between construction safety events in a graph database for knowledge map analysis and multi-hop query; and
step S7, in response to a natural language query for safety events of the construction site, regulatory recommendations, and accident handling solutions, performing cross-database and cross-modal RAG retrieval, comprising:
using the metadata index to retrieve one or more construction-site safety event logs indexed according to time, personnel, and event type;
using the vector database to perform semantic-level similarity and relevance-ranking retrieval of the vectorized data representing the construction-site safety event logs;
using the graph database to perform knowledge-map analysis and multi-hop querying of the relationships between construction safety events;
retrieving, from the construction-site safety log database, at least one of the one or more construction-site safety event logs using the metadata index and containing a violation record, together with screenshot or short-video evidence associated with the construction-site safety event log, retrieving regulations, cases, and standards from the public construction safety management database, and retrieving enterprise management measures from the enterprise internal safety management database;
inputting retrieved textual information comprising the construction-site safety event log containing the violation record, the regulations, the cases, the standards, and the enterprise management measures into a language model for integration to obtain integrated textual information;
generating a response based on the integrated textual information; and
displaying the response, the screenshot or short-video evidence, a handling basis, and corresponding handling measures.

2. The monitoring method of construction site safety based on large model and RAG as claimed in claim 1, comprising:
for each construction-site safety event log formed in step S2, adding a suggested rectification measure to the construction-site safety event log and storing, in a database, the construction-site safety event log together with a safety event image or a short video, wherein the short video has a duration of 5 to 10 seconds.

3. The monitoring method of construction site safety based on large model and RAG as claimed in claim 2, wherein in the step S6, the construction-site safety log database the public construction safety management database, and the enterprise internal safety management database are constructed through a multi-RAG architecture.

4. The monitoring method of construction site safety based on large model and RAG as claimed in claim 3, wherein the plurality of video collection devices are deployed in an elevated work area, an equipment operation area and a personnel crowded area.

5. A monitoring system of construction site safety based on large model and RAG, comprising:
a video collection module, configured to collect, by a plurality of video collection devices deployed at a construction site, real-time video data and real-time voice input data of a construction area;
a visual large model analysis system, configured to convert the real-time video data into key single-frame images, input the key single-frame images into a visual large model to perform object detection, OCR, and scene semantic understanding to identify behavioral safety of construction workers, violation operations, dangerous facilities and environmental risks, convert information identified by the visual large model into structured data comprising event type, occurrence time, occurrence location, involved personnel, violation description, equipment status, and risk level to obtain parsed safety event texts, and add time labels to the parsed safety event texts to thereby form construction-site safety event logs;
a reasoning analysis module, configured to input the construction-site safety event logs into a reasoning analysis model; apply the reasoning analysis model and construction safety rules to perform logical reasoning on the parsed safety event texts, extract key regulatory information, and evaluate safety risk levels to obtain reasoning analysis results, determine whether early safety warnings are to be generated based on the reasoning analysis results, and upon determining that the safety early warnings are to be generated, generate and push early warning information;
a voice broadcast module, configured to conduct on-site intelligent voice broadcast based on the early warning information, specifically comprising: send real-time early warning signals to wearable devices of construction workers based on the early warning information, for broadcasting the early warning information to the construction workers through the wearable devices thereby improving accessibility of safety supervision and ensuring that the construction workers in front-line can receive the early warning information in time;
a RAG retrieval module, configured to construct a construction-site safety log database a public construction safety management database, and an enterprise internal safety management database; construct a metadata index of the construction-site safety event logs according to time, personnel, and event type; convert the construction-site safety event logs into vectorized data using natural language processing technology; store the vectorized data representing the construction-site safety event logs in a vector database for semantic-level similarity and relevance-ranking retrieval; store relationships between construction safety events in a graph database for knowledge map analysis and multi-hop query; in response to receiving a natural language query, perform cross-database and cross-modal retrieval comprising using the metadata index to retrieve one or more construction-site safety event logs indexed according to time, personnel, and event type; using the vector database to perform semantic-level similarity and relevance-ranking retrieval of the vectorized data representing the construction-site safety event logs; using the graph database to perform knowledge-map analysis and multi-hop querying of the relationships between construction safety events; retrieving, from the construction-site safety log database, at least one of the one or more construction-site safety event logs using the metadata index and containing a violation record, together with screenshot or short-video evidence associated with the construction-site safety event log, retrieving regulations, cases, and standards from the public construction safety management database, and retrieving enterprise management measures from the enterprise internal safety management database; and output retrieval outputs comprising (i) retrieved textual information including the violation record, the regulations, the cases, the standards, and the enterprise management measures and (ii) the screenshot or short-video evidence;
a generation and storage module of construction history log texts, configured, for each construction-site safety event, to save a screenshot or a short video, bind the screenshot or the short video with text of a corresponding construction-site safety event log formed by the visual large model analysis system, and store, in the construction-site safety log database, the corresponding construction-site safety event log together with the bound screenshot or short video; and
a language interaction module, configured to, receive the natural language query for construction-site safety events regulatory recommendations, and accident handling solutions, submit the query to the RAG retrieval module; input the retrieved textual information of the retrieval outputs comprising the violation record, the regulations, the cases, the standards, and the enterprise management measures into a language model for integration to obtain integrated textual information; generate responses based on the integrated textual information; and display the response, the screenshot or short-video evidence, a handling basis, and corresponding handling measures;
wherein the video collection module, the visual large model analysis system, the reasoning analysis module, the voice broadcast module, the RAG retrieval module, the generation and storage module of construction history log texts, and the language interaction module are embodied by memories and processors coupled to the memories, and the memories are stored with computer programs executable by the processors.

6. The monitoring system of construction site safety based on large model and RAG as claimed in claim 5,
wherein the generation and storage module of construction history log texts is further configured to add a suggested rectification measure to each construction-site safety event log, and each short video stored by the generation and storage module has a duration of 5 to 10 seconds.

7. The monitoring system of construction site safety based on large model and RAG as claimed in claim 6, wherein, the plurality of video collection devices for the video collection module are deployed in an elevated work area, an equipment operation area and a personnel crowded area.

8-9. (canceled)
